(19) United States
(12) Patent Application Publication
(10) Pub. No.: US 2016/0172930 A1
(43) Pub. Date: Jun. 16, 2016

(54) LINEAR ACTUATOR FOR ADJUSTING FURNITURE COMPONENTS

(71) Applicant: DewertOkin GmbH, Kirchlengern (DE)

(72) Inventor: Andreas WELP, Minden (DE)

(21) Appl. No.: 14/937,313

(22) Filed: Nov. 10, 2015

Related U.S. Application Data
(62) Division of application No. 13/526,816, filed on Jun. 19, 2012, now abandoned.

(51) Int. Cl. H02K 7/06; A47C 7/50

(52) U.S. Cl. CPC H02K 7/06; A47C 7/506

(57) ABSTRACT

The invention relates to a linear actuator for adjusting furniture components relative to each other, where the linear actuator displays a screw jack with a guide section and a sliding element guided on the guide section, as well as a drive with an electric motor for driving the screw jack, and an electrical connection displaying a connecting cable for controlling the electric motor and/or supplying it with power.

### CROSS-REFERENCE TO RELATED APPLICATIONS

This application is a divisional application of U.S. application Ser. No. 13/526,816, filed Jun. 19, 2012, now pending, which is incorporated by reference.

### FIELD

The invention relates to a linear actuator for adjusting furniture components relative to each other, where the linear actuator displays a screw jack with a guide section and a sliding element guided on the guide section, as well as a drive with an electric motor for driving the screw jack, and an electrical connection displaying a connecting cable for controlling the electric motor and/or supplying it with power.

### BACKGROUND

A linear actuator is described, for example, in EP 0 787 267, where the electrical connection is located in the direct vicinity of the drive. Similarly, US 2011 0198 894 A1 describes a linear actuator whose connection is provided on the motor or on a part of the motor housing in order to adjust the foot section relative to the chair. This is particularly disadvantageous if, as in the case of a chair, the electric motor is to be located in the vicinity of the foot area. The consequence of this is that a cable has to be laid beneath the chair, from the back to the foot area at the front, in order to reach the electric motor. A disadvantage is that the cable can be pinched beneath the chair during adjustment. The customary remedy is to elaborately install the cable permanently on the chair.

### SUMMARY

The object of the invention is to provide a linear actuator of the kind mentioned in the opening paragraph that can be installed in a chair in simple fashion, without there being a risk of the cable being pinched in operation.

According to the invention, the object is solved by the characteristics of Claim 1. Advantageous developments are described in the sub-claims. The object is already solved by the connecting cable being guided on or in the guide section.

As a result, the connecting cable is guided on or in the guide section in a certain area, such that, even in the event of improper operation of the linear actuator, it cannot get into closing gaps or openings in the piece of furniture, where it could be pinched and dangerously damaged. The connecting cable is thus arranged so as to be guided in the longitudinal direction of the guide section. The connecting cable can thus be installed in stationary fashion relative to the guide section. The connecting cable can be installed so as to be immovable relative to the guide section, at least in this area. It can be permanently installed on or in the guide section.

In a preferred embodiment of the linear actuator, the guide section can display an oblong design feature delimiting a space for accommodating the connecting cable, such as a guide duct or a guide groove or guide channel that is open on the side, preferably towards the outside. As a result, the connecting cable can be arranged so as to be guided in the guide duct or guide groove. This provides additional protection for the connecting cable. If arranged in the guide groove, the connecting cable can also be laid in said groove at a later stage. In this context, clips or similar can be provided in the guide groove, for example, to fix the connecting cable in position. On the outside, the guide channel or groove can be bordered by a side rail that can preferably be slipped on laterally. This has the advantage that the connecting cable need not be laterally inserted into the guide groove until the linear actuator is fitted in the piece of furniture, after which said groove can be closed off with the side rail.

Alternatively, the connecting cable can be arranged so as to be guided at a parallel distance from the guide section. To this end, the connecting cable can be guided parallel to the guide section in the manner of an aerial line. In this context, the connecting cable can be exposed to preferably slight pretension, so that it can be permanently guided in a straight line.

Preferably the connecting cable is fixed on the outside of the guide section.

In a preferred embodiment of the linear actuator, the connecting cable can be arranged so as to be guided in or on a guide means, such as a tube or a web. The guide means can be arranged at a parallel distance from the guide section in this context. The connecting cable can thus continue to be protected.

The connecting cable can generally be fixed on or in the guide section at several points along its path parallel to the guide section. A first end of the guide section itself can extend away from the drive. To simplify the design, it is proposed that the connecting cable be fixed in stationary position relative to the first end in a first connecting area at the level of the first end.

The free end of the guide section can be provided with a closing element, on which the cable can be fixed in place in its first connecting area. The closing element can, in turn, be fixed in place on the guide section. It can display fastening means for fastening the linear actuator on the envisaged furniture component. The closing element can furthermore be designed as a face-end closure for the guide section, particularly one affording protection against dust and/or moisture. In the event of the connecting cable being guided in the guide section, the closing element can display a through-hole for leading the connecting cable out of the guide section.

In a further advantageous embodiment of the linear actuator, the connecting cable can be fixed in place in a second connecting area on the drive. In this context, the drive can display a housing with a further through-hole for the connecting cable. The connecting cable can be fixed in place in the through-hole. The first connecting area can thus be located at a distance from the second connecting area and at a distance from the drive.

In an advantageous embodiment of the linear actuator, the connecting cable can be protected against impermissible tensile stresses by means of a strain relief device in the first connecting area and/or the second connecting area. To avoid transmission of an external tensile stress to the connecting cable, the cable can be fixed in place by clamping or by means of screw connections, preferably in the first connecting area, preferably on the closing element. A screwed cable gland can also be provided. The connecting cable can display a cable sheath in which at least one or, expediently, at least two electrical lines are located. A cable bushing of elastic shape is preferably provided that is, for example, fixed on the outside of the cable sheath by frictional connection, or integrally molded on it or bonded to it, and that holds the connecting cable in a fixed position in the through-hole. The cable bushing can taper conically in the direction leading away from the linear actuator in order to laterally support the connecting cable in this way, i.e. in order to prevent kinking of the part of the connecting cable projecting from the through-hole in the event of it being bent over. The cable bushing can be located in the through-hole in locking fashion. It can be inserted laterally into the through-hole, forming a plug-in connection, the through-hole being laterally open to this end. The connecting cable can also display a flexible thicker area of the cable sheath in the first connecting area, in order to prevent kinking of the connecting cable on the closing element. To relieve the strain on the connecting cable, a tensioning element, such as a tensioning wire or a tensioning cable, can be provided, parallel to the connecting cable, e.g. between the drive and the first connecting area or the closing element, on which the connecting cable is fixed, preferably in axially sliding fashion.

On the closing element, the connecting cable can end in the form of a plug-type connecting element for connection to an extension cable. The connecting cable preferably displays a free end that extends away from the drive and bears the plug-type connecting element for connection to an extension cable. Particularly if the connecting cable is mounted on the closing element in kink-resistant fashion, the free end with the plug-type connecting element can be bent in the direction of the incoming extension cable without risk. The free end with the plug-type connecting element preferably extends a short distance beyond the first connecting area. The distance can be less than or equal to the axial length, preferably half the axial length, of the guide section.

### BRIEF DESCRIPTION OF THE DRAWINGS

The present invention is explained in more detail below on the basis of several embodiments of the linear actuator, taken in conjunction with following drawings:

FIG. 1 A perspective top view of a first embodiment of a linear actuator with guide section and connecting cable,

FIG. 2 A side view of the linear actuator according to FIG. 1,

FIG. 3 A cross-sectional view along line III-III in FIG. 2,

FIG. 4 A cross-sectional view along line IV-IV in FIG. 2,

FIG. 5 A perspective top view of a second embodiment of the linear actuator with guide section and connecting cable,

FIG. 6 A perspective top view of a third embodiment of the linear actuator with guide section and connecting cable,

FIG. 7a An enlarged section of the linear actuator of FIG. 1 on the end side of the guide section, with connecting cable fixed in place,

FIG. 7b An enlarged section of the linear actuator of FIG. 5 on the end side of the guide section, with connecting cable fixed in place,

FIG. 7c An enlarged section of the linear actuator of FIG. 6 on the end side of the guide section, with connecting cable fixed in place,

FIG. 8a A perspective view of the procedure for inserting the connecting cable in two steps, particularly the first step,

FIG. 8b A perspective view of the procedure for inserting the connecting cable in two steps, particularly the second step, and

FIG. 9 A perspective top view of a fourth embodiment of the linear actuator with guide section and connecting cable.

### DETAILED DESCRIPTION

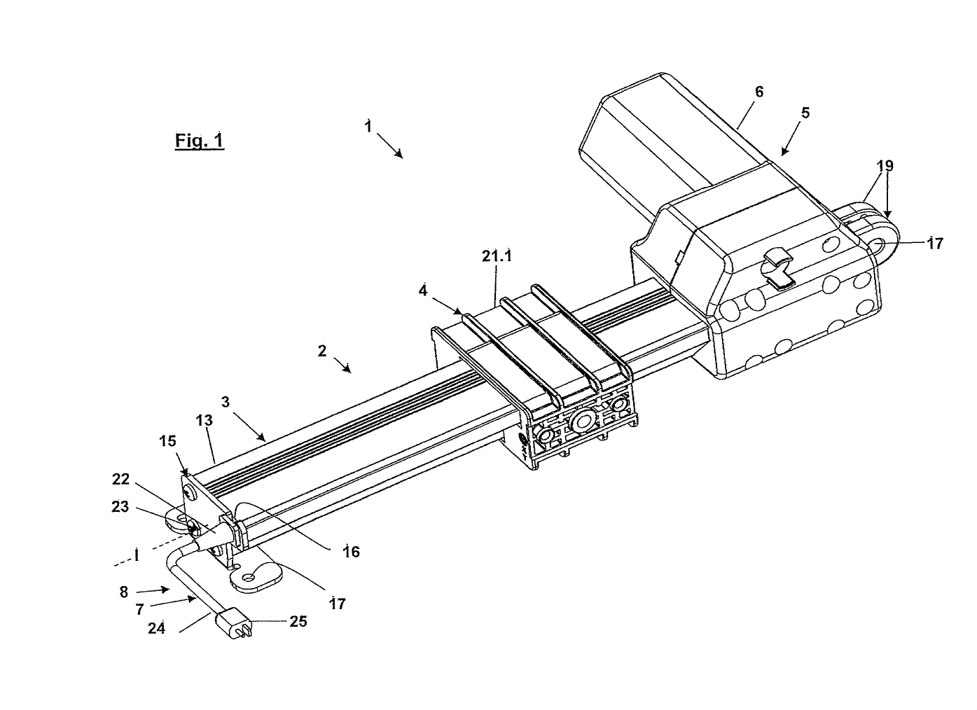

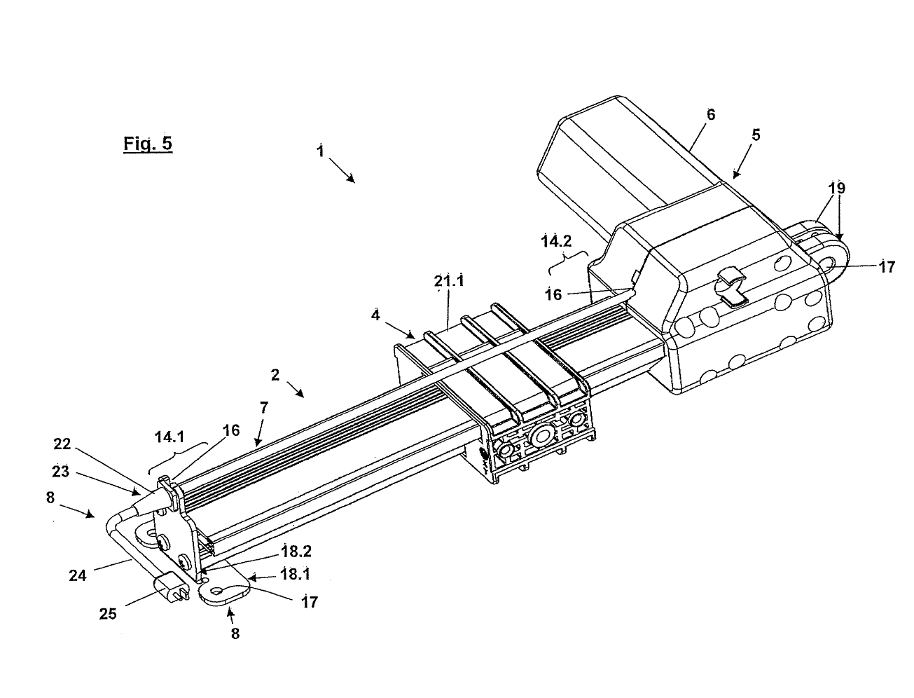

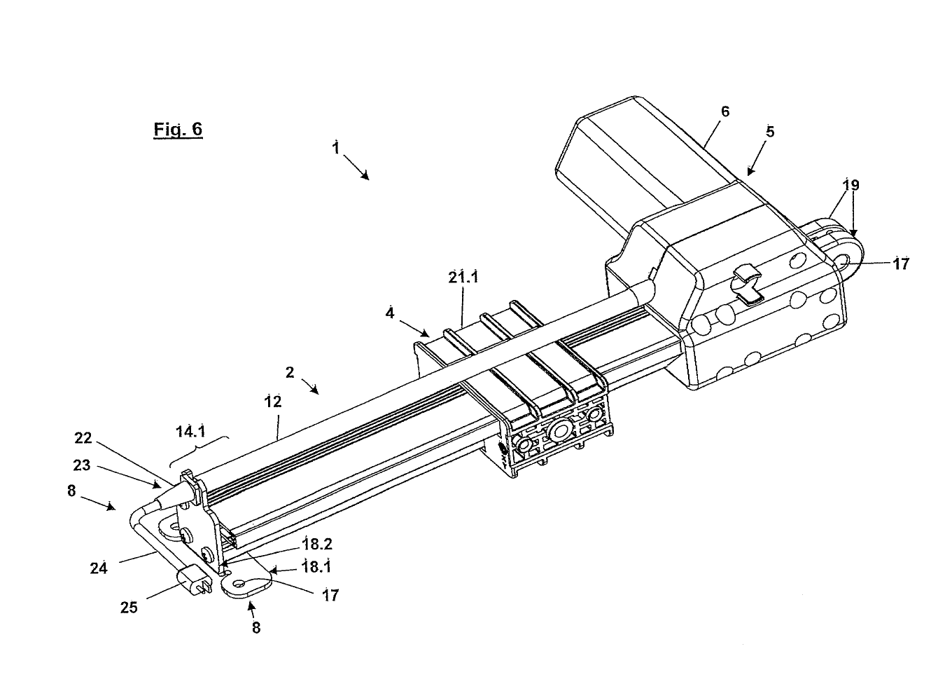

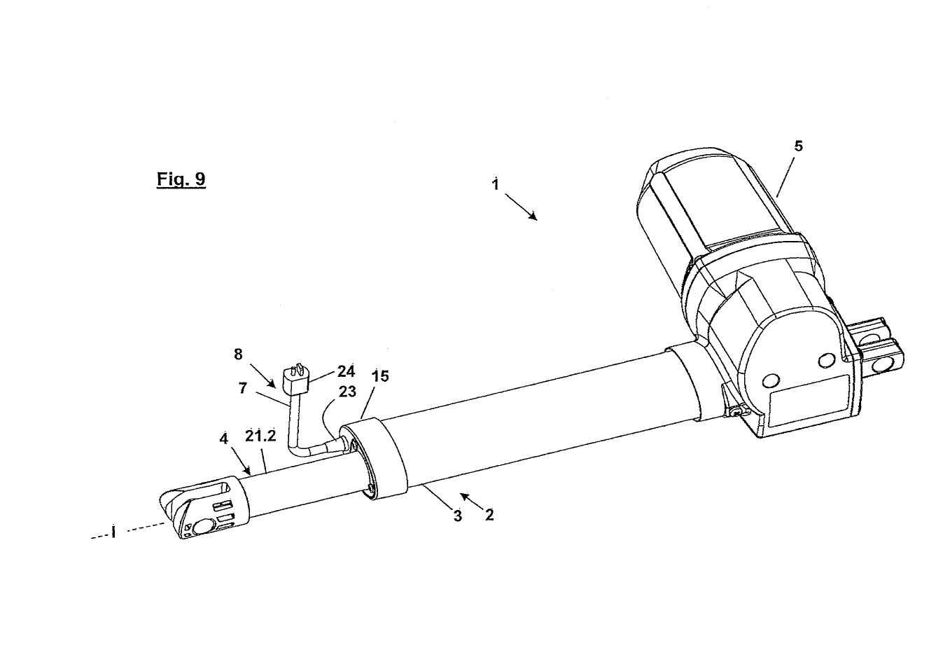

FIGS. 1 to 9 show, in different perspective views and details, four embodiments of a linear actuator 1 for adjusting furniture components (not shown here) relative to each other. Linear actuator 1 displays a screw jack 2 with a guide section 3 and a sliding element 4, guided on guide section 3, as well as a drive 5 with an electric motor 6 for driving screw jack 2, and an electrical connection 8, displaying a connecting cable 7, for controlling electric motor 6 and/or supplying it with power. In all embodiments of linear actuator 1, connecting cable 7 is guided along guide section 3 in longitudinal direction 1 of the guide section 3. In this context, connecting cable 7 is arranged so as to be guided in guide section 3 in the embodiments of linear actuator 1 according to FIG. 1 and FIG. 9. In the embodiments of linear actuator 1 according to FIGS. 5 and 6, connecting cable 7 is arranged so as to be guided on linear actuator 1. Connecting cable 7 is laid in fixed position relative to guide section 3 in all embodiments of linear actuator 1 shown here. It is arranged in stationary and non-moving fashion relative to guide section 3 in the area in which it is guided in or on guide section 3.

In the embodiments of linear actuator 1 according to FIGS. 1 and 9, guide section 3 displays an oblong design feature delimiting a space 9 for accommodating connecting cable 7—in this case, in the form of a guide groove 10 according to FIG. 1 or in the form of a guide duct (hidden) according to FIG. 9. The arrangement of guide groove 10 in guide section 3 can be seen from the cross-sectional representations in FIGS. 3 and 4. In this instance, guide groove 10 is additionally covered by a side rail 11 that can be slipped on laterally, such that connecting cable 7 is arranged in protected fashion in space 9. As a result, connecting cable 7 need not be inserted laterally into guide groove 10 until the time of installation of linear actuator 1 in the piece of furniture not shown here, and it can easily be removed from guide groove 10 again for repairs.

In the embodiments of linear actuator 1 according to FIGS. 5 and 6, connecting cable 7 is in each case arranged so as to be guided at a parallel distance from guide section 3. In this context, connecting cable 7 is tensioned in FIG. 5 and protected in a tube 12 in FIG. 6.

A free end 13 of guide section 3 extends away from drive 5. In all embodiments of linear actuator 1, the connecting cable is fixed in stationary position on guide section 3 in a first connecting area 14.1 at the level of free end 13 of guide section 3. To this end, a closing element 15 is provided on the face end of guide section 3, closing off and protecting guide section 3. As can be seen in FIG. 4, closing element 15 is fixed in place on the face end on guide section 3 by means of screws 16.

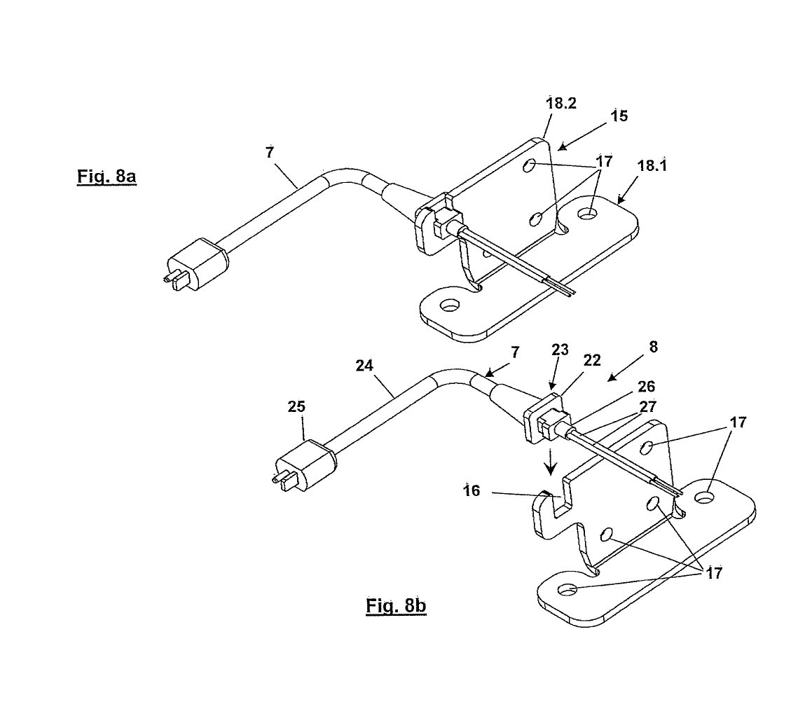

Closing element 15 displays a through-hole 16, designed in the manner of a slit in this case, for passing through and fixing connecting cable 7 (FIG. 8b). Closing element 15 furthermore displays fastening openings 17.1 for fixing linear actuator 1 on a piece of furniture not shown here. Closing element 15 is in this instance made from a pre-stamped piece of sheet metal that is bent into a L shape to produce two legs, a first leg 18.1 with fastening openings 17.1 for fastening linear actuator 1 on the piece of furniture, and a second leg 18.2, where second leg 18.2 covers the end side of guide section 3 and displays through-hole 16 and fastening openings 17.1 for screwing closing element 15 to guide section 3. In FIG. 4, the screw connection is indicated by schematically illustrated screws 17.2, which engage the face end of guide section 3 in longitudinal direction 1, i.e. perpendicularly to the drawing plane. Referring to the embodiment of linear actuator 1 illustrated in FIGS. 1, 5 and 6, FIGS. 7a and 7b each show an enlarged section of free end 13 of guide section 3, with closing element 15 screwed on at the face end. FIGS. 8a and 8b show the insertion of connecting cable 7 with strain relief device 23 into laterally open through-hole 16 in two steps. The Figures indicate that combination of the types of guidance shown is also possible, in that one connecting cable is guided in the guide section and one connecting cable on the guide section.

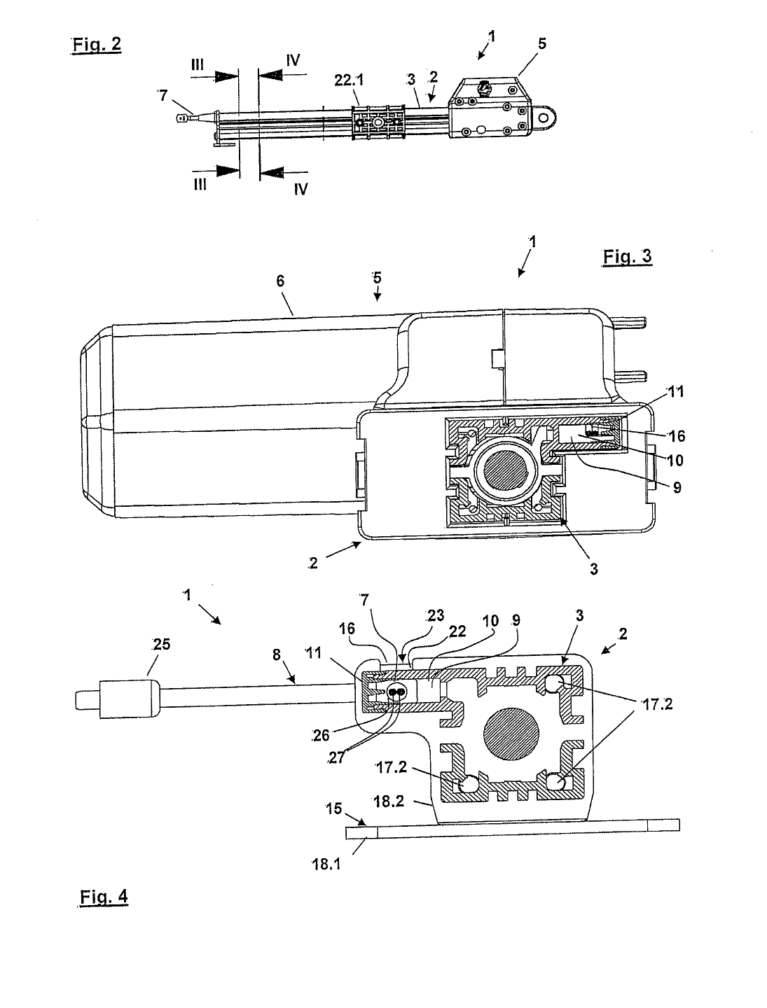

As can particularly be seen from FIGS. 2 and 3, drive 5 is provided with tabs 19 with further fastening openings 17.1 for fastening linear actuator 1 on the piece of furniture. Linear actuator 1 is held on the piece of furniture by means of fastening openings 17.1 on drive 5 and those on closing element 15. As sliding element 4, linear actuator 1 displays a sliding carriage 21.1 (FIGS. 1 to 8) or a sliding tube 21.2 (FIG. 9) for connecting linear actuator 1 to another furniture component (not shown) that is to be moved relative to the one furniture component by means of linear actuator 1. Possible lever mechanisms for force transmission are not shown here.

Connecting cable 7 is fixed in place in a second connecting area 14.2 on drive 5, in this case on housing 20 of same. Second connecting area 14.2 is axially arranged at a distance from first connecting area 14.1.

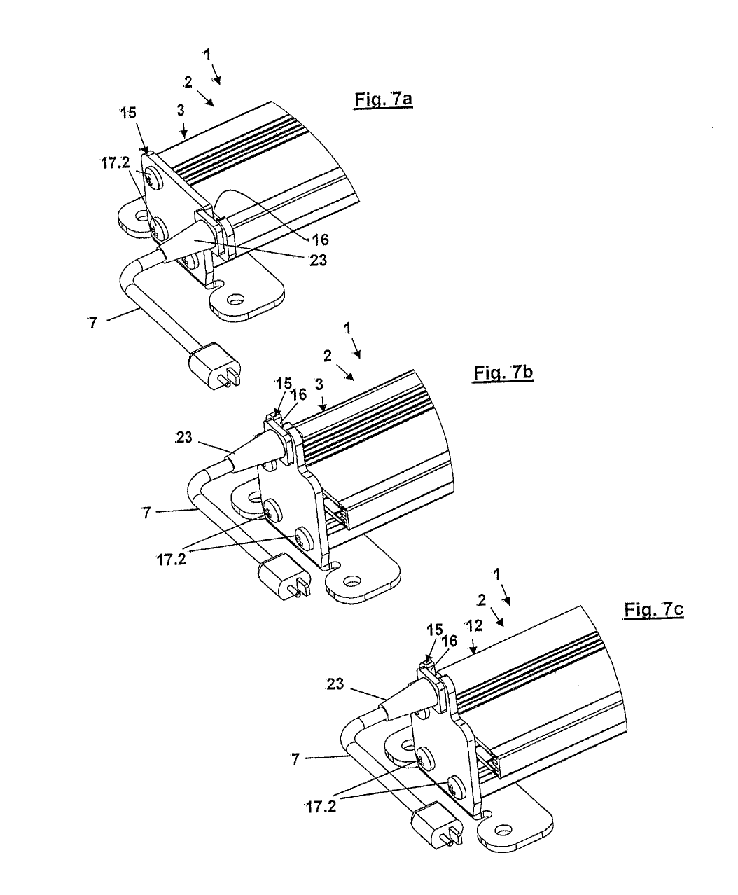

Connecting cable 7 is arranged in first connecting area 14.1 so as to be protected against impermissible tensile stresses by means of a strain relief device 23, designed as cable bushing 22, where cable bushing 22 is slid on along connecting cable 7 and fixed on its outside. Through-hole 16 is laterally open, as can clearly be seen in FIGS. 7 and 8, such that cable bushing 22 with connecting cable 7 can be inserted laterally into through-hole 16 (FIG. 8). Forming a plug-type connection with through-hole 16, cable bushing 22 reaches over the through-hole on both sides. This allows a tensile stress to be transmitted from cable bushing 22 to closing element 15. As can particularly be seen from FIG. 8b, showing closing element 15 and cable bushing 22, through-hole 16 and cable bushing 22 have rectangular cross-sections adapted to each other, as a result of which cable bushing 22 is retained in through-hole 16 in non-rotating fashion.

Connecting cable 7 displays a free end 24, extending away from drive 5, with a plug-type connecting element on the end, designed in this instance as electric plug 25, for connection to an extension cable or similar (not shown here), where free end 24 extends a distance beyond through-hole 16 and can be bent freely. To counteract kinking when bending free end 24 of connecting cable 7, cable bushing 22 tapers conically towards free end 24, such that connecting cable 7 is laterally supported flexibly by cable bushing 22 beyond through-hole 16. In this instance, connecting cable 7 displays an outer cable sheath 26 and two electrical lines 27 on the inside.

### LIST OF REFERENCE NUMBERS

1 Linear actuator
2 Screw jack
3 Guide section
4 Sliding element
5 Drive
6 Electric motor
7 Connecting cable
8 Connection
9 Space
10 Guide groove
11 Side rail
12 Tube
13 End
14.1 First connecting area
14.2 Second connecting area
15 Closing element
16 Through-hole
17.1 Fastening opening
17.2 Screw
18.1 First leg
18.2 Second leg
19 Tab
20 Housing
21.1 Sliding carriage
21.2 Sliding tube
22 Cable bushing
23 Strain relief device
24 End
25 Plug
26 Cable sheath
27 Line
l Longitudinal direction

What is claimed is:

1. A linear actuator to adjust furniture components relative to each other, the linear actuator comprising:
a screw jack with a guide section and a sliding element guided on the guide section,
a drive with an electric motor to drive the screw jack,
an electrical connection comprising a connecting cable to at least one of control the electric motor and supply the electric motor with power,
wherein a free end of the guide section extends away from the drive,
wherein the connecting cable comprises a free end that extends away from the drive at a level of the free end of the guide section,
wherein the connecting cable is fixed in stationary position relative to the free end of the guide section in a first connecting area at the level of the free end of the guide section, and
wherein the connecting cable overlies the sliding element on the guide section such that the sliding element is slideable on the guide section between the connecting cable and the guide section.

2. (canceled)

3. The linear actuator according to claim 1, wherein the connecting cable is arranged to be guided at a parallel distance from the guide section along a length of the guide section.

4. The linear actuator according to claim 1, wherein the connecting cable is fixed on an outside of the guide section.

5. The linear actuator according to claim 1, wherein the connecting cable is arranged so as to be guided in or on a guide means.

6. (canceled)

7. The linear actuator according to claim 1, wherein the free end of the guide section is provided with a closing element, on which the cable is fixable in place in its first connecting area.

8. The linear actuator according to claim 7, wherein the closing element is fixed in place on the guide section and comprises fastening means to fasten the linear actuator on a furniture component.

9. The linear actuator according to claim 1, wherein the connecting cable is fixed in place in a second connecting area on the drive.

10. The linear actuator according to claim 6, wherein the connecting cable is protected against tensile stresses by a strain relief device in the first connecting area.

11. The linear actuator according to claim 10, wherein a cable bushing of elastic shape is provided as the strain relief device, which is fixable in place on the first connecting area of the connecting cable and in a through-hole provided in a closing element.

12. The linear actuator according to claim 1, wherein the connecting cable comprises a free end that extends away from the drive and bears a plug-type connecting element.
